(19) United States
(12) Patent Application Publication
(10) Pub. No.: US 2025/0007189 A1
(43) Pub. Date: Jan. 2, 2025

(54) CABLE CONNECTOR DEVICE THAT IS CONFIGURED TO MITIGATE ALIEN CROSSTALK

(71) Applicant: BELDEN CANADA ULC, SAINT-LAURENT (CA)

(72) Inventors: Virak SIEV, Montreal (CA); Michael BODZAY, Dollard-Des Ormeaux (CA); Alain DESROCHERS, LES CEDRES (CA)

(73) Assignee: BELDEN CANADA ULC, SAINT-LAURENT, QC (CA)

(21) Appl. No.: 18/761,064

(22) Filed: Jul. 1, 2024

Related U.S. Application Data
(60) Provisional application No. 63/524,128, filed on Jun. 29, 2023.

(51) Int. Cl. H01R 9/24

(52) U.S. Cl. CPC H01R 9/2425

(57) ABSTRACT

A connector is configured to connect cables so as to mitigate alien crosstalk. The connector includes a body portion and an alien crosstalk mitigation portion. The alien crosstalk mitigation portion has a first shield portion and a second shield portion. The second shield portion is structurally configured to be electrically connected to the first shield portion. The second shield portion comprises a first shield connection portion structurally configured to electrically connect to a first cable shield portion of the first cable and a second shield connection portion structurally configured to electrically connect to a second cable shield portion of the second cable. The first shield portion is structurally configured to electrically connect with the first and second cable shield portions. The alien crosstalk mitigation portion is structurally configured to electrically connect with the first and second cable shield portions to mitigate alien crosstalk by 3 dB or more to the conductors of the cables from a cabling system.

### CROSS REFERENCE TO RELATED APPLICATION

This application claims the benefit of U.S. Provisional Application No. 63/524,128, filed Jun. 29, 2023, the disclosure of which is hereby incorporated by reference herein in its entirety.

### TECHNICAL FIELD

The present disclosure generally relates to a connector for connecting cables. More specifically, the disclosure relates to such a connector for connecting cables that provides enhanced alien cross talk performance.

### BACKGROUND

Traditionally, connectors such as terminal block connectors were designed to connect cables carrying power or control signals, but not data signals. Therefore, transmission parameters like crosstalk and balance that may occur with cables carrying data signals weren't considered during the design. In recent development, these connectors could also be used to connect cables carrying data signals, such as via Single Pair Ethernet (SPE) which may result in improper balance and excessive alien crosstalk.

FIG. 1 illustrates a typical terminal block connector 100. The terminal block connector 100 may be used to make an electrical connection between individual conductors of the cables being connected. The terminal block connector 100 typically has a plastic body 102, receiving portions 104 for receiving the conductors of the cables to be connected, metallic plates 106, a bar 108 and screws 110. After inserting conductors of the cables to be connected in the receiving portions 104, the conductors may be in contact with the plates 106 and/or the bar 108 and the screws may be adjusted such that the conductors are pressed against the bar 110 to make an electrical connection between the conductors of the cables and the bar. In some embodiments, the terminal block connectors 100 may be colored corresponding to the conductors to be connected.

In a typical SPE terminal block deployment, each corresponding conductor of an SPE cable may be connected to its own terminal block connector 100. For example, as shown in FIG. 2, a first data conductor 210 may be connected to a red terminal block connector 204, a second data conductor 208 may be connected to a black terminal block connector 202, and a ground conductor 212 (if present) may be connected to a gray terminal block connector 206 (although non-colored or otherwise colored terminal block connectors could be used). In a typical deployment, the terminal block connectors may be placed or mounted directly adjacent to one another in a row as illustrated in FIG. 2. As such, the gray terminal block connector (if present) would typically be placed either to the left or right of the two data terminal block connectors 204, 208.

The disposition of the conductors and the terminal block connectors next to each other may cause an imbalanced coupling within a pair of the SPE conductors, and between adjacent pairs of the SPE conductors, as shown in FIG. 3. Within a pair of the SPE conductors, the coupling is shown as the C1 and C2 capacitances, between the black conductor 302 and the shield conductor 306, and between the red conductor 304 and the shield conductor 306, respectively. Because the red terminal block connector is adjacent to the gray terminal block connector, the C2 capacitance is greater than the C1 capacitance by 3 dB or more (i.e., C2 is dominant). This inequivalence between C1 and C2 is the imbalanced coupling (or imbalanced noise) within a conductor pair.

Between adjacent pairs, coupling passes via the gray terminal block. The black terminal block of pair 2 is closer to the gray terminal block of pair 1, therefore the C3 capacitance is greater (i.e., dominant) than C4. The two dominant capacitances (C2 and C3) create an imbalanced coupling between adjacent pairs (i.e., Alien Crosstalk). The conductors may also receive alien crosstalk from other components in a cabling system of which the cables are a part.

As illustrated in FIG. 4, between two pairs of the SPE conductors 402, 404 where each pair is without a ground conductor, the coupling is shown as the C1, C2, C3 and C4 capacitances. A similar imbalanced coupling exists between the adjacent pairs because C1≠C2, C2≠C3, C3C4, and C1≠C4. The imbalances described above and alien crosstalk will deteriorate the cabling system's ability to transmit data signals.

It may therefore be desirable to provide a terminal block connector that provides a balanced level of crosstalk. For example, it may be desirable to provide a connector having an alien crosstalk mitigation portion that is structurally configured to electrically connect with the first and second cable shield portions of first and second cables so as to provide an enhanced level of alien crosstalk of 3 dB or more to the conductors of the cables from a cabling system.

### SUMMARY

According to embodiments of the disclosure, a connector is configured to connect cables so as to mitigate alien crosstalk. The connector includes a body portion and an alien crosstalk mitigation portion. The alien crosstalk mitigation portion has a first shield portion and a second shield portion. The second shield portion is structurally configured to be electrically connected to the first shield portion. The second shield portion comprises a first shield connection portion structurally configured to electrically connect to a first cable shield portion of the first cable and a second shield connection portion structurally configured to electrically connect to a second cable shield portion of the second cable. The first shield portion is structurally configured to electrically connect with the first and second cable shield portions. The alien crosstalk mitigation portion is structurally configured to electrically connect with the first and second cable shield portions to mitigate alien crosstalk by 3 dB or more to the conductors of the cables from a cabling system.

According to embodiments of the disclosure, a connector is configured to connect cables so as to mitigate alien crosstalk. The connector includes a body portion and an alien crosstalk mitigation portion. The body portion includes a first body portion and a second body portion, the first body portion includes a cover portion that is structurally configured to be selectively removed from the second body portion to expose the second body portion for connection of the cables to the second body portion, wherein the first body portion comprises a cover portion that is structurally configured to be selectively removed from the second body portion to expose the second body portion for connection of the cables to the second body portion, the second body portion comprises a receiving portion configured to receive conductors of a first cable and conductors of a second cable, the alien crosstalk mitigation portion comprises a first shield portion and a second shield portion, the first shield portion is structurally configured to fit within an opening portion in the first body portion and to be attached to the first body portion, the second shield portion is structurally configured to be attached to the first shield portion, the first shield portion is structurally configured to be removed from the second shield portion with the first body portion when the first body portion is removed from the second body portion, the second shield portion comprises a first shield connection portion structurally configured to electrically connect to a first cable shield portion of the first cable and a second shield connection portion structurally configured to electrically connect to a second cable shield portion of the second cable, the first shield portion is structurally configured to electrically connect with the first and second cable shield portions when the first body portion and the first shield portion are connected to the second body portion, and the alien crosstalk mitigation portion is structurally configured to electrically connect with the first and second cable shield portions so as to mitigate alien crosstalk by 3 dB or more to the conductors of the cables from a cabling system.

According to embodiments of the disclosure, a connector is configured to connect cables so as to mitigate alien crosstalk. The connector includes a body portion and an alien crosstalk mitigation portion. The first body portion includes a cover portion that is configured to be selectively removed from the second body portion to expose the second body portion for connection of the cables to the second body portion, the second body portion includes receiving portions configured to receive conductors of a first cable and conductors of a second cable, the alien crosstalk mitigation portion includes a first shield portion and a second shield portion, the second shield portion is structurally configured to be attached to the first shield portion, the second shield portion includes a first shield connection portion structurally configured to electrically connect to a first cable shield portion of the first cable and a second shield connection portion structurally configured to electrically connect to a second cable shield portion of the second cable, the first shield portion is structurally configured to electrically connect with the first and second cable shield portions when the first body portion and the first shield portion are connected to the second body portion, and the alien crosstalk mitigation portion is structurally configured to electrically connect with the first and second cable shield portions so as to mitigate alien crosstalk by 3 dB or more to the conductors of the cables from a cabling system.

### BRIEF DESCRIPTION OF THE DRAWINGS

Further advantages and features of the present disclosure will become apparent from the following detailed description and the accompanying drawings.

FIG. 1 illustrates a terminal block connector in accordance with various aspects of the disclosure.

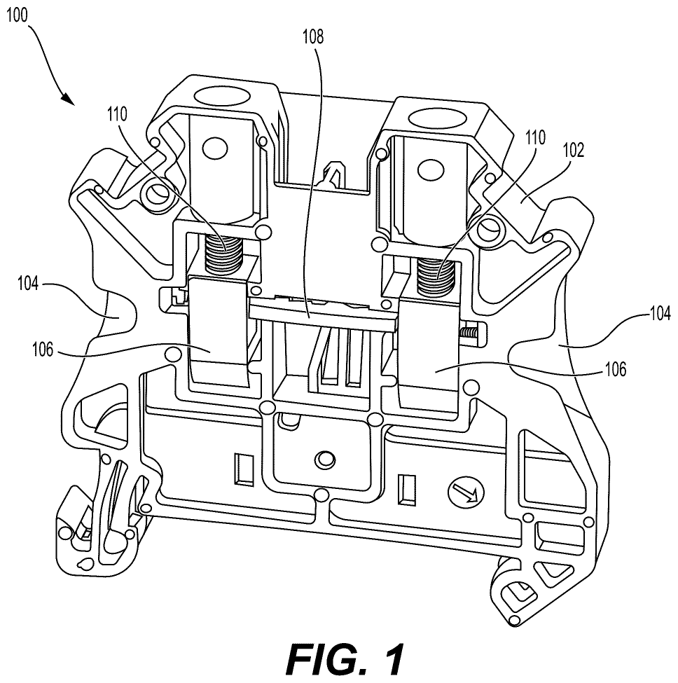

FIG. 2 illustrates terminal block connectors in accordance with various aspects of the disclosure.

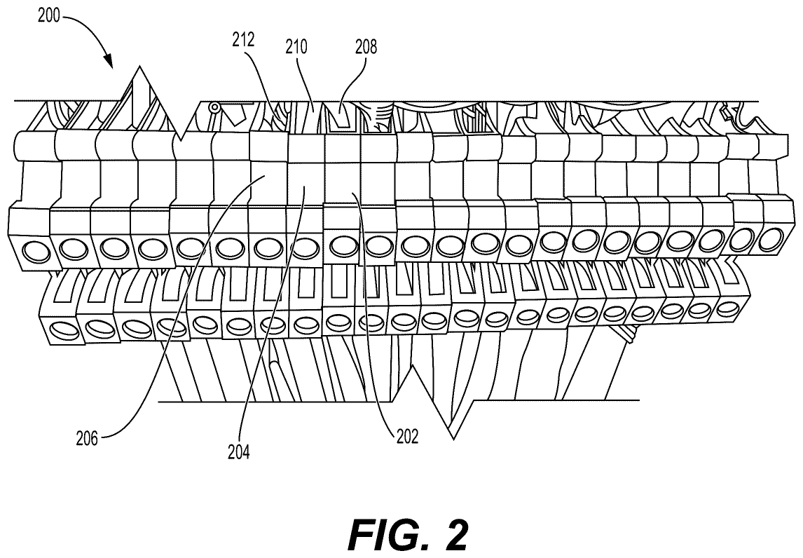

FIG. 3 illustrates imbalanced coupling of SPE conductors in accordance with various aspects of the disclosure.

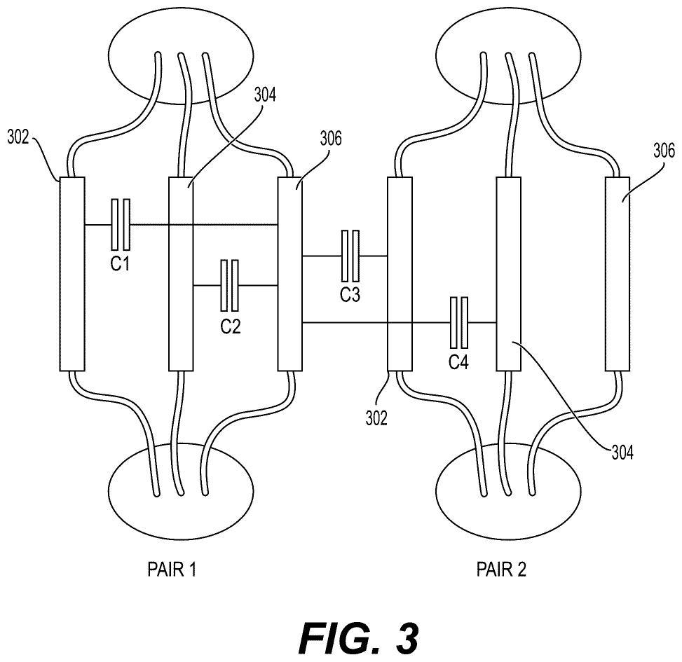

FIG. 4 illustrates imbalanced coupling of and alien crosstalk of cable conductors in accordance with various aspects of the disclosure.

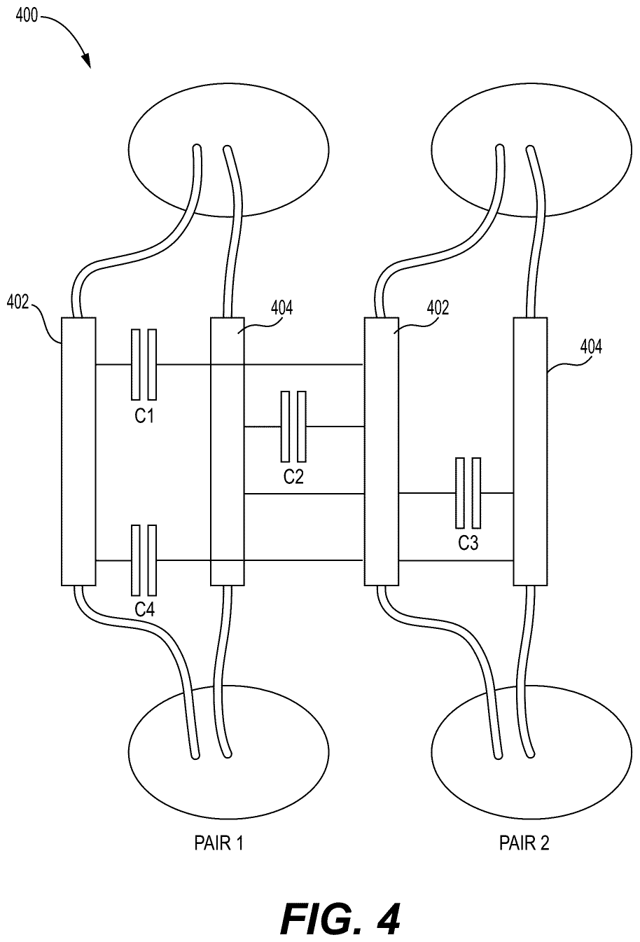

FIG. 5 illustrates connection elements in accordance with various aspects of the disclosure.

FIG. 6 illustrates connection elements in accordance with various aspects of the disclosure.

FIG. 7 illustrates connection elements in accordance with various aspects of the disclosure.

FIG. 8 illustrates connection elements in accordance with various aspects of the disclosure.

FIG. 9 illustrates a terminal block connecting device with a in accordance with various aspects of the disclosure.

FIG. 10 illustrates a connector in accordance with various aspects of the disclosure.

FIG. 11 illustrates cables connected with the connectors in accordance with various aspects of the disclosure.

FIG. 12 illustrates a portion of the connector in accordance with various aspects of the disclosure.

FIG. 13 illustrates a graph of alien crosstalk levels at various frequencies in accordance with various aspects of the disclosure.

### DETAILED DESCRIPTION

Reference will now be made in detail to presently preferred embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure. Furthermore, the terminology used herein is used only for the purpose of describing particular embodiments of the present disclosure and is not intended to be limiting in any way.

As used in the specification and the appended claims, the singular form “a,” “an,” and “the” include plural referents unless the context clearly indicates otherwise. For example, reference to a component in the singular is intended to also include a plurality of components.

There are multiple embodiments disclosed herein, all of which implement a form of the terminal block connector device to improve balance and provide a reduction in alien crosstalk and with balanced crosstalk. There are some unique features relative to standard terminal block connectors that may be used with any of the embodiments as follows:
The metal transmission plate may be replaced with a thinner metallic transmission pathway optimized for the power current and voltage ratings. This could be a lead frame type as in an RJ45 connectors, a Printed Circuit Board, with 18 awg wires, or metal pins.
The screws used to create a compression contact between the conductors and the metal transmission plate may be replaced with other mechanical features capable of applying a compression force. This could be a spring, a cam, or protrusion in a secondary body portion. The compression mechanism may be electrical isolated. This may be achieved by making the mechanism of a non-conductive material such as plastic, or by adding a non-conductive barrier layer between the mechanism and conductor.
The connection method between the conductors and the transmission pathway within the connector may be changed to an IDC style termination as opposed to a compression style termination. In this implementation the IDC could be formed as part of the lead frame that creates the electrical transmission pathways.
A single compression method for the input side and one for the output side could be used, i.e., one screw would apply the necessary force to some or all of the conductors on the input side for the conductors to make proper electrical contact with their respective transmission pathways.

Specifically, the connector shield portion (alien crosstalk mitigation portion) of various embodiments disclosed herein may be embodied within a connector (such as a terminal block connector). The connector shield portion is configured to provide an improvement in alien crosstalk from a cabling system, as further described herein.

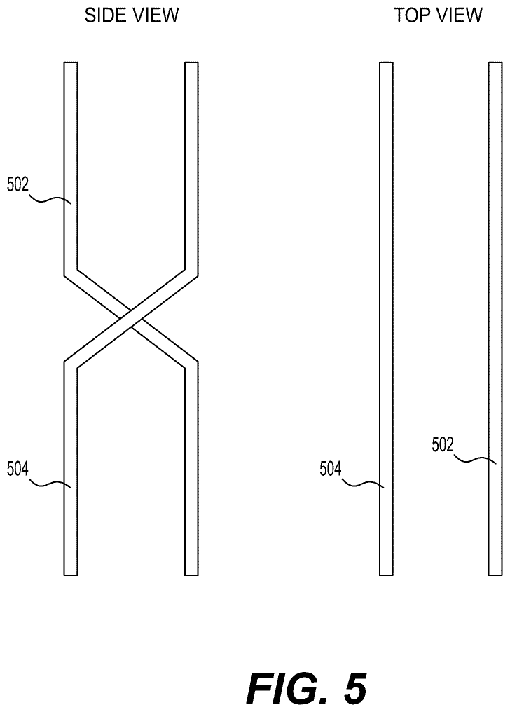

In an embodiment such as illustrated in FIG. 5, the two connection elements are configured to include parallel paths to one another (either vertically, horizontally, or on some angle). For example, as illustrated in the top view of FIG. 5, the paths of the coupling balancing elements 502, 504 may be parallel and then cross at some mid-point such that the left is on the right and vice versa (or up/down, etc. as in the side view of FIG. 5). The terminal block connector may have two inputs and two outputs for the two data conductors of a SPE cable to be connected and may optionally include a third input and output for a ground conductor if present. The internal configuration of the interconnection between input and output of the data ports is the coupling balancing elements which balances the crosstalk from adjacent terminal block connectors.

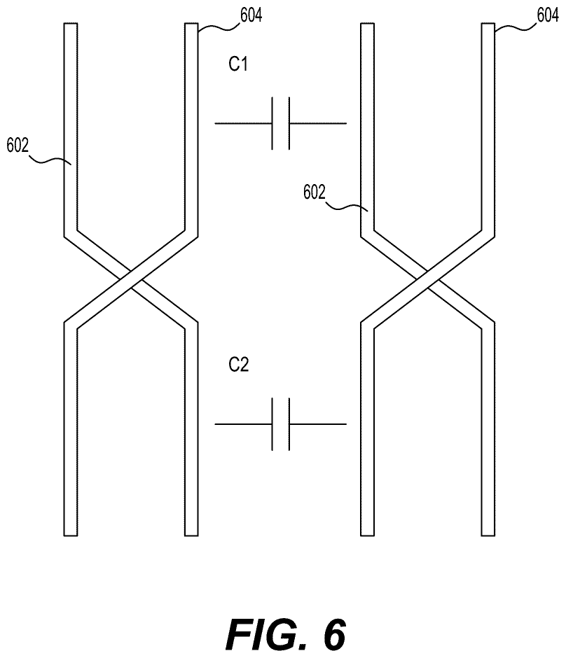

The parallel nature of the paths with the crossing is configured to balance the crosstalk such that capacitances C1=C2 representing crosstalk between adjacent pairs of SPE conductors. C1 and C2 being exactly equal is not required to balance the crosstalk. As illustrated in FIG. 6, the two connection elements 602, 604 are coupling balancing elements that are parallel in one plane but cross each other in another plane and function as compensation structure for balancing a crosstalk between the conductors.

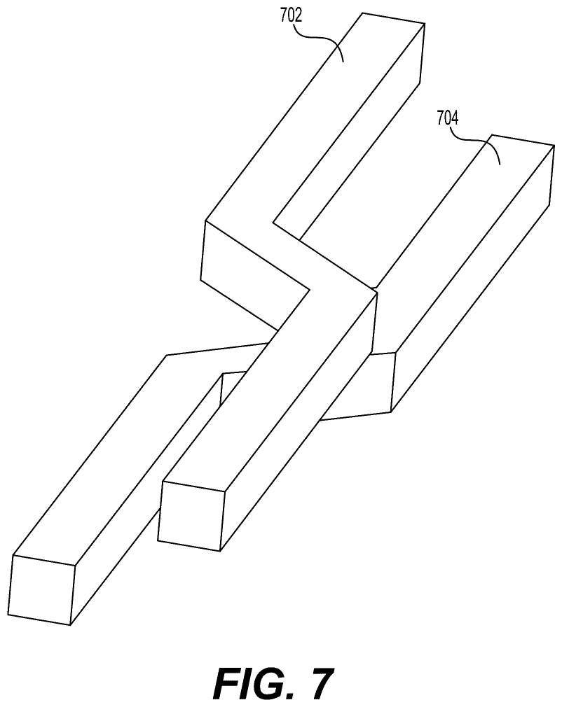

As illustrated in FIG. 7, coupling balancing elements 702, 704 are also configured to be parallel in a first plane but to cross in another plane. The crossing position may be at or near a center of the coupling balancing elements 702, 704. The two coupling balancing elements are parallel to one another in the plane from front to back but the paths are bent at some angle to one another. The angular nature of the path decreases the capacitive coupling between adjacent pathways because it is caused by parallel electrical elements. Thus, the angle mitigates the crosstalk between adjacent connectors.

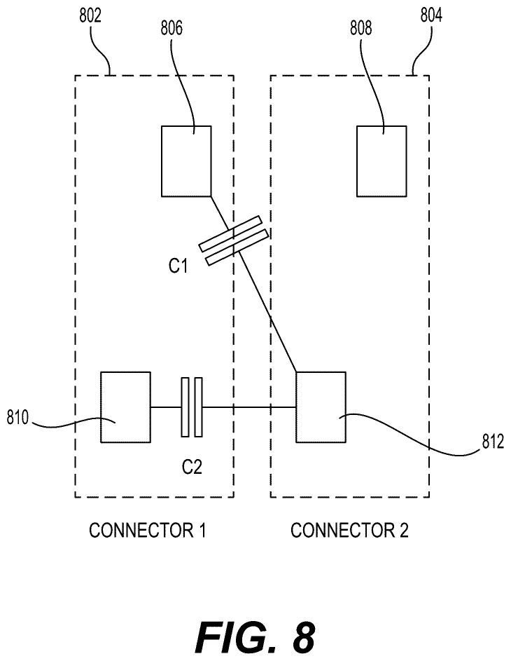

As illustrated in FIG. 8, terminal block connecting elements 802, 804 are positioned adjacent to each other with connecting elements for blue conductors 806, 808 and red conductors 810, 812. By offsetting the position of the pathways of the connecting elements within the terminal block connectors 802, 804, the distance between adjacent connector pathways is also increased. An increase in pathway distance decreases the capacitive couple, thereby mitigating the crosstalk between adjacent terminal blocks. Additionally, the offset distance is optimized such that C1=C2. This is achieved by ensuring the distance between the red connecting element of the first terminal block connector and red connecting element of the second terminal block connector is equal to the distance between the blue connecting element of the first terminal block connector and the red connecting element of the second terminal block connector.

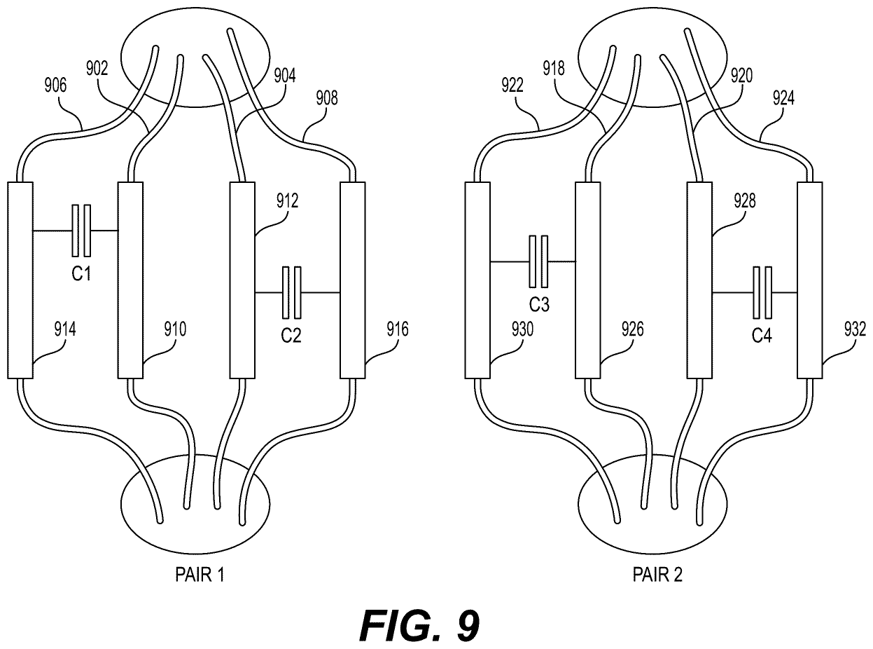

As illustrated in FIG. 9, two pairs of conductors 902, 904 may be connected with two other pairs of conductors, which in some embodiments may be conductors of an SPE cable, may be connected using terminal block connectors 910, 912, 926, 928. The terminal blocks 914, 916, 930, 932 are used to connect shield conductors 906, 908, 922, 924 with the terminal block connectors equally spaced on both sides of each pair of the terminal block connectors 910, 912, 926, 928. This results in balancing of the coupling such that C1=C2 and C3=C4.

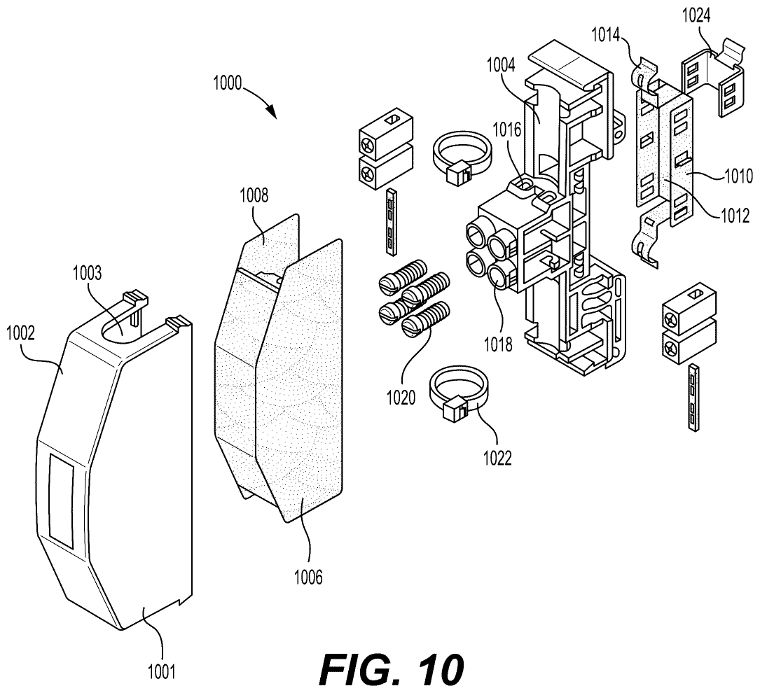

FIG. 10 illustrates a connector 1000 that may be used in accordance with various embodiments. In some embodiments, the connector 1000 may be a terminal block connector configured for connecting cables, although other connectors could be used. The terminal block connector 1000 may include a body portion 1001 that includes a shell or first body portion 1002 and a base or second body portion 1004, and a connector shield portion (alien crosstalk mitigation portion) 1006. The connector shield portion 1006 may include a first connector shield portion 1008 and a second connector shield portion 1010.

The body portion 1001 may be formed from a non-conductive material such as plastic. The connector shield portion 1006 may be formed from a conductive material such as a metal, which in some embodiments may be a copper or copper alloy material.

The shell or first body portion 1002 may include a hollow inner portion and a cable receiving portion 1003. The base or second body portion 1004 may include conductor receiving portions 1016 configured to receive conductors of cables being connected and contacting portions 1018 configured to receive contacting elements 1020. In some embodiments, the contacting elements 1020 may be in the form of screws, although other types of contacting elements could be used.

The first connector shield portion 1008 may have a complementary shape to the first body portion 1002 of the body portion 1001 and may be configured to ft within and be removably retained within the first body portion 1002. The second connector shield portion 1010 may have a complementary shape to the second body portion 1004 and may be configured to attach thereto. The second connector shield portion 1010 may also have cable shield contacting portions 1014 configured to attach to a shield of cables being connected with the connector 1000. In some embodiments, cable retaining portions 1022 may be utilized to retain the cables in position within the connector 1000.

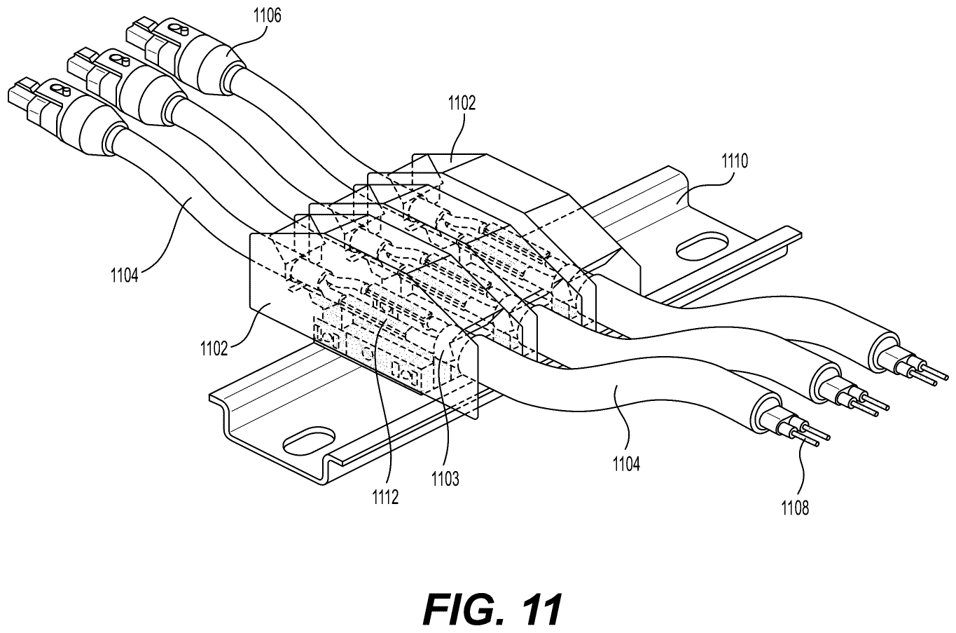

FIG. 11 illustrates a plurality of cables 1104 being connected with a plurality of adjacent connectors 1102. The cables 1104 may be connected to the connectors 1102 by inserting conductors 1108 of the cables 1104 into the receiving portions 1016. Shield portions 1103 of the cables contact with the shield contacting portions 1014 of the connector shield portion 1006. The connectors 1102 may include conductor connecting portions (sometimes referred to as tines) 1112 configured to make an electrical connection between conductors of the cables. The conductor connecting portions 1112 may be formed of a conductive material, such as a metallic material. The connectors 1102 may be terminal block connectors. The connectors may be configured to connect to a rail, which in some embodiments may be a DIN rail.

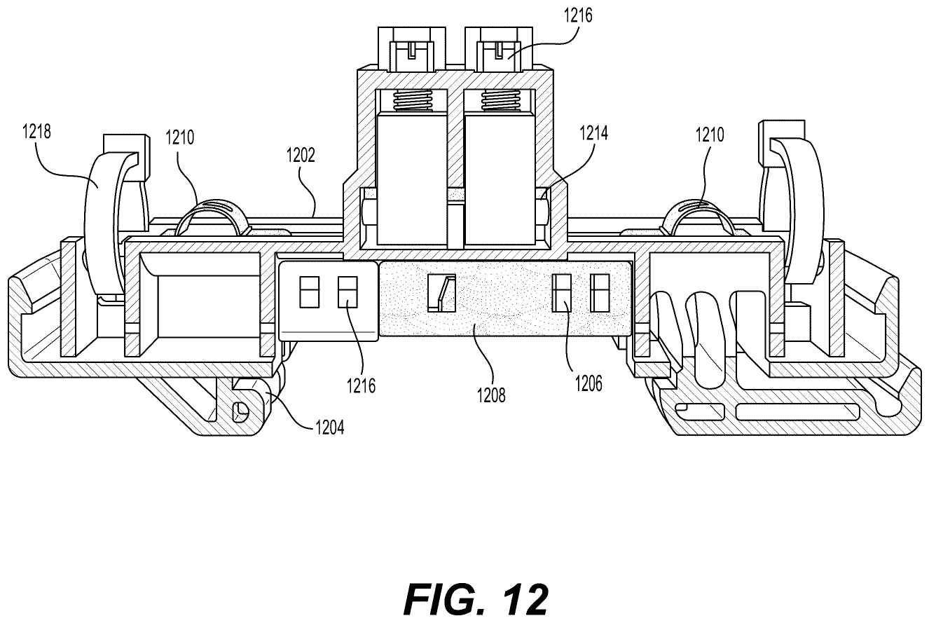

FIG. 12 illustrates a base or second portion 1202 of the body portion of the connector connected to a second portion 1208 of a connector shield portion, with the shell or first body portion 1002 and the first portion of the connector shield portion 1008 removed.

The connector 1000 is configured to have the cables connected thereto in this condition, with the cables having exposed conductors and an exposed shield portion where the outer jacket of the cables has been stripped back. The exposed portion of the conductors 1108 of the cables are inserted into the conductor receiving portions 1018 and the exposed shield portions 1103 (FIG. 11) of the cables are contacted with the cable shield contacting portions 1014 (FIG. 10), 1210. In some embodiments, the cable retaining portion 1022, 1218 may be used to retain the cables in position. The connecting portions 1214 are configured to connect the conductors of the cables and to create an electrical pathway within the connector 1000. The screws 1216 are screwed down after the conductors of the cables are inserted to urge or push the cable conductors into electrical contact with the connecting portions 1214 forming the electrical pathway connecting the two conductors inserted from opposite sides of the connector 1000.

After the conductors of the cables are connected, the first body portion 1002 with the first connector shield portion 1008 retained therein may be lowered over and connected to the second body portion 1004. When so connected, the first connector shield portion 1008 is configured to connect to the shield portion of the cables and to the second connector shield portion 1010 to form a shield around the conductors and around the connecting portions 1214.

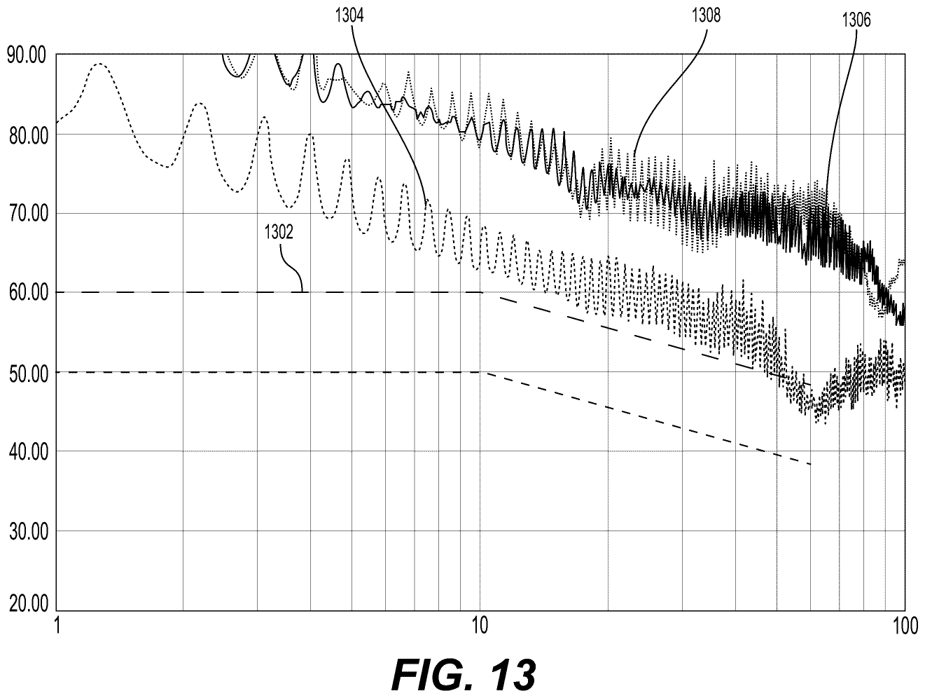

FIG. 13 illustrates alien crosstalk levels in dB at various frequencies. The line 1302 illustrates an acceptable level of alien crosstalk. The line 1302 illustrates a baseline level of alien crosstalk in a terminal block connecting device. Lines 1306 and 1308 illustrate alien crosstalk levels for the embodiments with the connector as illustrated in FIGS. 10-12. As illustrated, the connector of these embodiments provides an improvement in the level of alien crosstalk of 3 dB or more in a cabling system. The cabling system may include all the components used between two active equipment elements (like a switch and a computer) and the single pair ethernet cables and connectors may be a part of that cabling system.

While multiple non-limiting embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A connector configured to connect cables so as to mitigate alien crosstalk, comprising:
a body portion;
an alien crosstalk mitigation portion configured to shield cables from alien crosstalk;
wherein the body portion comprises a first body portion and a second body portion;
wherein the first body portion comprises a cover portion that is structurally configured to be selectively removed from the second body portion to expose the second body portion for connection of the cables to the second body portion;
wherein the second body portion comprises a receiving portion configured to receive conductors of a first cable and conductors of a second cable;
wherein the alien crosstalk mitigation portion comprises a first shield portion and a second shield portion;
wherein the first shield portion is structurally configured to fit within an opening portion in the first body portion and to be attached to the first body portion;
wherein the second shield portion is structurally configured to be attached to the first shield portion;
wherein the first shield portion is structurally configured to be removed from the second shield portion with the first body portion when the first body portion is removed from the second body portion;
wherein the second shield portion comprises a first shield connection portion structurally configured to electrically connect to a first cable shield portion of the first cable and a second shield connection portion structurally configured to electrically connect to a second cable shield portion of the second cable;
wherein the first shield portion is structurally configured to electrically connect with the first and second cable shield portions when the first body portion and the first shield portion are connected to the second body portion; and
wherein the alien crosstalk mitigation portion is structurally configured to electrically connect with the first and second cable shield portions so as to mitigate alien crosstalk by 3 dB or more to the conductors of the cables from a cabling system.

2. The connector of claim 1, wherein the body portion comprises a plastic material configured to reduce a weight of the connector.

3. The connector of claim 1, wherein the body portion further comprises a first connection portion structurally configured to electrically connect a first conductor of the first cable to a first conductor of the second cable and a second connection portion structurally configured to connect a second conductor of the first cable to a second conductor of the second cable.

4. The connector of claim 3, wherein the body portion further comprises an urging portion structurally configured to urge the first and second conductors of the respective first and second cables into electrical contact with the first and second connection portions.

5. The connector of claim 1, wherein the alien crosstalk mitigation portion comprises a conductive material configured to provide the mitigated level of alien crosstalk.

6. The connector of claim 1, wherein the body portion comprises a non-conductive material configured to protect the alien crosstalk mitigation portion from electrical contact.

7. The connector of claim 1, further comprising a first retaining portion and a second retaining portion structurally configured to retain the first and second cables within the connector.

8. A connector configured to connect cables so as to mitigate alien crosstalk, comprising:
a body portion comprising a first body portion and a second body portion;
an alien crosstalk mitigation portion configured to provide a shield to the cables from alien crosstalk;
wherein the first body portion comprises a cover portion that is configured to be selectively removed from the second body portion to expose the second body portion for connection of the cables to the second body portion;
wherein the second body portion comprises receiving portions configured to receive conductors of a first cable and conductors of a second cable;
wherein the alien crosstalk mitigation portion comprises a first shield portion and a second shield portion;
wherein the second shield portion is structurally configured to be attached to the first shield portion;
wherein the second shield portion comprises a first shield connection portion structurally configured to electrically connect to a first cable shield portion of the first cable and a second shield connection portion structurally configured to electrically connect to a second cable shield portion of the second cable;
wherein the first shield portion is structurally configured to electrically connect with the first and second cable shield portions when the first body portion and the first shield portion are connected to the second body portion; and
wherein the alien crosstalk mitigation portion is structurally configured to electrically connect with the first and second cable shield portions so as to mitigate alien crosstalk by 3 dB or more to the conductors of the cables from a cabling system.

9. The connector of claim 8, wherein the first shield portion is structurally configured to fit within an opening portion in the first body portion and to be attached to the first body portion.

10. The connector of claim 8, wherein the first shield portion is structurally configured to be removed from the second shield portion with the first body portion when the first body portion is removed from the second body portion.

11. The connector of claim 8, wherein the body portion comprises a plastic material configured to reduce a weight of the connector.

12. The connector of claim 8, wherein the body portion further comprises a first connection portion structurally configured to electrically connect a first conductor of the first cable to a first conductor of the second cable and a second connection portion structurally configured to connect a second conductor of the first cable to a second conductor of the second cable.

13. The connector of claim 12, wherein the body portion further comprises an urging portion structurally configured to urge the first and second conductors of the respective first and second cables into electrical contact with the first and second connection portions.

14. The connector of claim 8, wherein the alien crosstalk mitigation portion comprises a conductive material configured to provide the enhanced level of alien crosstalk.

15. The connector of claim 8, wherein the body portion comprises a non-conductive material configured to protect the alien crosstalk mitigation portion from electrical contact.

16. The connector of claim 8, further comprising a first retaining portion and a second retaining portion structurally configured to retain the first and second cables within the connector.

17. A connector configured to connect cables so as to mitigate alien crosstalk, comprising:
a body portion;
an alien crosstalk mitigation portion configured to provide a shield to the cables from alien crosstalk;
wherein the alien crosstalk mitigation portion comprises a first shield connection portion structurally configured to electrically connect to a first cable shield portion of the first cable and a second shield connection portion structurally configured to electrically connect to a second cable shield portion of the second cable;
wherein the alien crosstalk mitigation portion is structurally configured to electrically connect with the first and second cable shield portions; and
wherein the alien crosstalk mitigation portion is structurally configured to electrically connect with the first and second cable shield portions so as to mitigate alien crosstalk by 3 dB or more to the conductors of the cables from a cabling system.

18. The connector of claim 17, wherein the alien crosstalk mitigation portion is structurally configured to fit within an opening portion in the body portion and to be attached to the body portion.

19. The connector of claim 17, wherein the body portion comprises a plastic material configured to reduce a weight of the connector.

20. The connector of claim 19, wherein the body portion further comprises a first connection portion structurally configured to electrically connect a first conductor of the first cable to a first conductor of the second cable and a second connection portion structurally configured to connect a second conductor of the first cable to a second conductor of the second cable.

21. The connector of claim 19, wherein the body portion further comprises an urging portion structurally configured to urge the first and second conductors of the respective first and second cables into electrical contact with the first and second connection portions.

22. The connector of claim 17, wherein the alien crosstalk mitigation portion comprises a conductive material configured to provide the mitigation in alien crosstalk.

23. The connector of claim 17, wherein the body portion comprises a non-conductive material configured to protect the alien crosstalk mitigation portion from electrical contact.
